(19) United States
(12) Patent Application Publication
(10) Pub. No.: US 2023/0401972 A1
(43) Pub. Date: Dec. 14, 2023

(54) SYSTEMS AND METHODS FOR PROVIDING PERSONALIZED LEARNING INTERVENTION

(71) Applicant: TouchMath Acquisition LLC, Colorado Springs, CO (US)

(72) Inventor: Scott Andrews, Colorado Springs, CO (US)

(21) Appl. No.: 18/334,019

(22) Filed: Jun. 13, 2023

Related U.S. Application Data
(60) Provisional application No. 63/352,088, filed on Jun. 14, 2022.

(51) Int. Cl. G09B 7/00

(52) U.S. Cl. CPC G09B 7/00

(57) ABSTRACT

Embodiments are directed to providing personalized learning intervention in an online learning environment. As described herein, personalized learning intervention can include performing an online diagnostic of a student, setting a set of learning targets for the student based on results of performing the online diagnostic, and guiding progress along a learning path based on the set of learning targets. The learning path can be a sequence of learning points, each learning point relating to a skill to be learned. Reinforcement learning can be performed with the student based on results of guiding the progress along the learning path.

### CROSS REFERENCE TO RELATED APPLICATION

The present application claims the benefits of and priority, under 35 U.S.C. § 119(e), to U.S. Provisional Application No. 63/352,088 filed Jun. 14, 2022 by Andrews and entitled “Systems and Methods for Providing Personalized Learning Intervention” of which the entire disclosure is incorporated herein by reference for all purposes.

### FIELD OF THE DISCLOSURE

Embodiments of the present disclosure relate generally to methods and systems for online learning and more particularly to providing personalized learning intervention in an online learning environment.

### BRIEF DESCRIPTION OF THE DRAWINGS

FIG. 1 is a block diagram illustrating elements of an exemplary computing environment in which embodiments of the present disclosure may be implemented.

FIG. 2 is a block diagram illustrating elements of an exemplary computing device in which embodiments of the present disclosure may be implemented.

FIG. 3 is a block diagram illustrating an exemplary environment for providing personalized learning intervention according to one embodiment of the present disclosure.

FIG. 4 is a flowchart illustrating an exemplary process for providing personalized learning intervention according to one embodiment of the present disclosure.

FIG. 5 is a flowchart illustrating additional details of an exemplary process for performing diagnostics according to one embodiment of the present disclosure.

FIG. 6 is a flowchart illustrating additional details of an exemplary process for setting learning targets according to one embodiment of the present disclosure.

FIG. 7 is a flowchart illustrating additional details of an exemplary process for guiding progress according to one embodiment of the present disclosure.

FIG. 8 is a flowchart illustrating additional details of an exemplary process for performing reinforcement according to one embodiment of the present disclosure.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

In the following description, for the purposes of explanation, numerous specific details are set forth in order to provide a thorough understanding of various embodiments disclosed herein. It will be apparent, however, to one skilled in the art that various embodiments of the present disclosure may be practiced without some of these specific details. The ensuing description provides exemplary embodiments only and is not intended to limit the scope or applicability of the disclosure. Furthermore, to avoid unnecessarily obscuring the present disclosure, the preceding description omits a number of known structures and devices. This omission is not to be construed as a limitation of the scopes of the claims. Rather, the ensuing description of the exemplary embodiments will provide those skilled in the art with an enabling description for implementing an exemplary embodiment. It should however be appreciated that the present disclosure may be practiced in a variety of ways beyond the specific detail set forth herein.

While the exemplary aspects, embodiments, and/or configurations illustrated herein show the various components of the system collocated, certain components of the system can be located remotely, at distant portions of a distributed network, such as a Local-Area Network (LAN) and/or Wide-Area Network (WAN) such as the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the following description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, Non-Volatile Random-Access Memory (NVRAM), or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a Compact Disk Read-Only Memory (CD-ROM), any other optical medium, punch cards, paper tape, any other physical medium with patterns of holes, a Random-Access Memory (RAM), a Programmable Read-Only Memory (PROM), and Erasable Programmable Read-Only Memory (EPROM), a Flash-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

A “computer readable signal” medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, Radio Frequency (RF), etc., or any suitable combination of the foregoing.

The terms “determine,” “calculate,” and “compute,” and variations thereof, as used herein, are used interchangeably and include any type of methodology, process, mathematical operation or technique.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as Programmable Logic Device (PLD), Programmable Logic Array (PLA), Field Programmable Gate Array (FPGA), Programmable Array Logic (PAL), special purpose computer, any comparable means, or the like. In general, any device(s) or means capable of implementing the methodology illustrated herein can be used to implement the various aspects of this disclosure. Exemplary hardware that can be used for the disclosed embodiments, configurations, and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or Very Large-Scale Integration (VLSI) design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or Common Gateway Interface (CGI) script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

Various additional details of embodiments of the present disclosure will be described below with reference to the figures. While the flowcharts will be discussed and illustrated in relation to a particular sequence of events, it should be appreciated that changes, additions, and omissions to this sequence can occur without materially affecting the operation of the disclosed embodiments, configuration, and aspects.

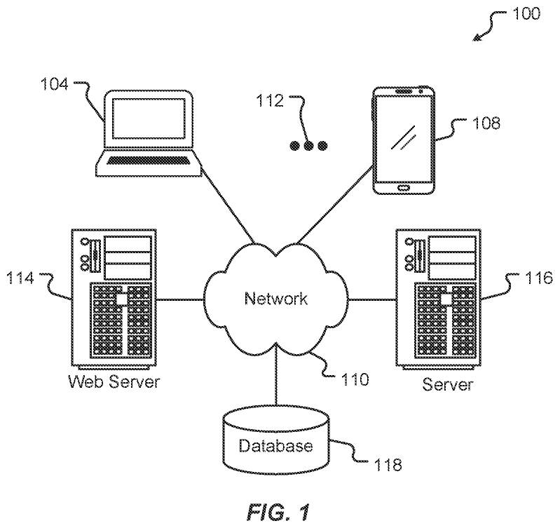

FIG. 1 is a block diagram illustrating elements of an exemplary computing environment in which embodiments of the present disclosure may be implemented. More specifically, this example illustrates a computing environment 100 that may function as the servers, user computers, or other systems provided and described herein. The environment 100 includes one or more user computers, or computing devices, such as a computing device 104, a communication device 108, and/or more 112. The computing devices 104, 108, 112 may include general purpose personal computers (including, merely by way of example, personal computers, and/or laptop computers running various versions of Microsoft Corp.'s Windows® and/or Apple Corp.'s Macintosh® operating systems) and/or workstation computers running any of a variety of commercially-available UNIX® or UNIX-like operating systems. These computing devices 104, 108, 112 may also have any of a variety of applications, including for example, database client and/or server applications, and web browser applications. Alternatively, the computing devices 104, 108, 112 may be any other electronic device, such as a thin-client computer, Internet-enabled mobile telephone, and/or personal digital assistant, capable of communicating via a network 110 and/or displaying and navigating web pages or other types of electronic documents. Although the exemplary computer environment 100 is shown with two computing devices, any number of user computers or computing devices may be supported.

Environment 100 further includes a network 110. The network 110 may can be any type of network familiar to those skilled in the art that can support data communications using any of a variety of commercially-available protocols, including without limitation Session Initiation Protocol (SIP), Transmission Control Protocol/Internet Protocol (TCP/IP), Systems Network Architecture (SNA), Internetwork Packet Exchange (IPX), AppleTalk, and the like. Merely by way of example, the network 110 maybe a Local Area Network (LAN), such as an Ethernet network, a Token-Ring network and/or the like; a wide-area network; a virtual network, including without limitation a Virtual Private Network (VPN); the Internet; an intranet; an extranet; a Public Switched Telephone Network (PSTN); an infra-red network; a wireless network (e.g., a network operating under any of the IEEE 802.9 suite of protocols, the Bluetooth® protocol known in the art, and/or any other wireless protocol); and/or any combination of these and/or other networks.

The system may also include one or more servers 114, 116. In this example, server 114 is shown as a web server and server 116 is shown as an application server. The web server 114, which may be used to process requests for web pages or other electronic documents from computing devices 104, 108, 112. The web server 114 can be running an operating system including any of those discussed above, as well as any commercially-available server operating systems. The web server 114 can also run a variety of server applications, including SIP servers, HyperText Transfer Protocol (secure) (HTTP(s)) servers, FTP servers, CGI servers, database servers, Java servers, and the like. In some instances, the web server 114 may publish operations available operations as one or more web services.

The environment 100 may also include one or more file and or/application servers 116, which can, in addition to an operating system, include one or more applications accessible by a client running on one or more of the computing devices 104, 108, 112. The server(s) 116 and/or 114 may be one or more general purpose computers capable of executing programs or scripts in response to the computing devices 104, 108, 112. As one example, the server 116, 114 may execute one or more web applications. The web application may be implemented as one or more scripts or programs written in any programming language, such as Java™, C, C #®, or C++, and/or any scripting language, such as Perl, Python, or Tool Command Language (TCL), as well as combinations of any programming/scripting languages. The application server(s) 116 may also include database servers, including without limitation those commercially available from Oracle®, Microsoft®, Sybase®, IBM® and the like, which can process requests from database clients running on a computing device 104, 108, 112.

The web pages created by the server 114 and/or 116 may be forwarded to a computing device 104, 108, 112 via a web (file) server 114, 116. Similarly, the web server 114 may be able to receive web page requests, web services invocations, and/or input data from a computing device 104, 108, 112 (e.g., a user computer, etc.) and can forward the web page requests and/or input data to the web (application) server 116. In further embodiments, the server 116 may function as a file server. Although for ease of description, FIG. 1 illustrates a separate web server 114 and file/application server 116, those skilled in the art will recognize that the functions described with respect to servers 114, 116 may be performed by a single server and/or a plurality of specialized servers, depending on implementation-specific needs and parameters. The computer systems 104, 108, 112, web (file) server 114 and/or web (application) server 116 may function as the system, devices, or components described herein.

The environment 100 may also include a database 118. The database 118 may reside in a variety of locations. By way of example, database 118 may reside on a storage medium local to (and/or resident in) one or more of the computers 104, 108, 112, 114, 116. Alternatively, it may be remote from any or all of the computers 104, 108, 112, 114, 116, and in communication (e.g., via the network 110) with one or more of these. The database 118 may reside in a Storage-Area Network (SAN) familiar to those skilled in the art. Similarly, any necessary files for performing the functions attributed to the computers 104, 108, 112, 114, 116 may be stored locally on the respective computer and/or remotely, as appropriate. The database 118 may be a relational database, such as Oracle 20i®, that is adapted to store, update, and retrieve data in response to Structured Query Language (SQL) formatted commands.

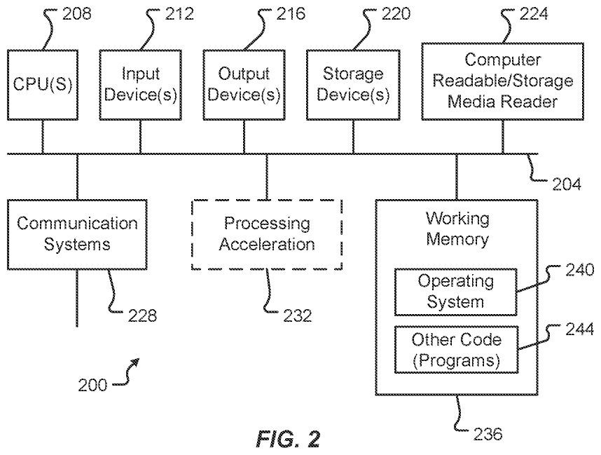

FIG. 2 is a block diagram illustrating elements of an exemplary computing device in which embodiments of the present disclosure may be implemented. More specifically, this example illustrates one embodiment of a computer system 200 upon which the servers, user computers, computing devices, or other systems or components described above may be deployed or executed. The computer system 200 is shown comprising hardware elements that may be electrically coupled via a bus 204. The hardware elements may include one or more Central Processing Units (CPUs) 208; one or more input devices 212 (e.g., a mouse, a keyboard, etc.); and one or more output devices 216 (e.g., a display device, a printer, etc.). The computer system 200 may also include one or more storage devices 220. By way of example, storage device(s) 220 may be disk drives, optical storage devices, solid-state storage devices such as a Random-Access Memory (RAM) and/or a Read-Only Memory (ROM), which can be programmable, flash-updateable and/or the like.

The computer system 200 may additionally include a computer-readable storage media reader 224; a communications system 228 (e.g., a modem, a network card (wireless or wired), an infra-red communication device, etc.); and working memory 236, which may include RAM and ROM devices as described above. The computer system 200 may also include a processing acceleration unit 232, which can include a Digital Signal Processor (DSP), a special-purpose processor, and/or the like.

The computer-readable storage media reader 224 can further be connected to a computer-readable storage medium, together (and, optionally, in combination with storage device(s) 220) comprehensively representing remote, local, fixed, and/or removable storage devices plus storage media for temporarily and/or more permanently containing computer-readable information. The communications system 228 may permit data to be exchanged with a network and/or any other computer described above with respect to the computer environments described herein. Moreover, as disclosed herein, the term “storage medium” may represent one or more devices for storing data, including ROM, RAM, magnetic RAM, core memory, magnetic disk storage mediums, optical storage mediums, flash memory devices and/or other machine-readable mediums for storing information.

The computer system 200 may also comprise software elements, shown as being currently located within a working memory 236, including an operating system 240 and/or other code 244. It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed.

Examples of the processors 208 as described herein may include, but are not limited to, at least one of Qualcomm® Snapdragon® 800 and 801, Qualcomm® Snapdragon® 620 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

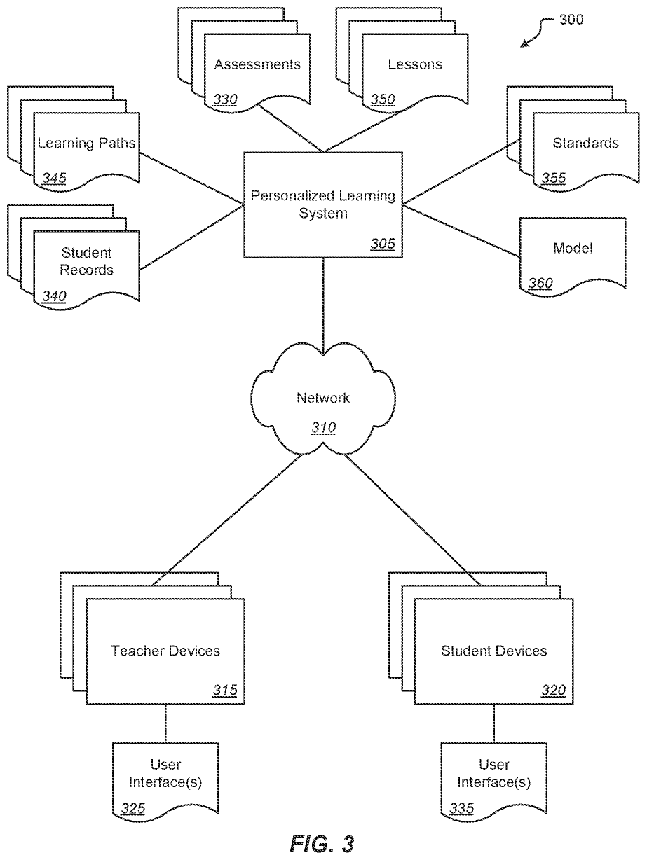

FIG. 3 is a block diagram illustrating an exemplary environment for providing personalized learning intervention according to one embodiment of the present disclosure. As illustrated in this example, this environment 300 can include a personalized learning system 305. The personalized learning system 305 can comprise one or more servers and/or other computing devices as described above. The personalized learning system 305 can be communicative coupled with one or more networks 310. The one or more networks 310 can comprise any one or more wired and/or wireless, local and/or wide area networks as described above and can include, but is not limited to, the Internet. Also coupled with the network(s) 310 can be any number of teacher devices 315 and any number of student devices 320. Each of the teacher devices 315 and each of the student devices 320 can comprise any type of computing device as described above including, but not limited to a desktop computer, laptop computer, tablet, smart phone, etc.

Generally speaking, the personalized learning system 305 can present a set of user interfaces 325, such as webpages or other graphical and/or textual presentations, to the teacher devices 315 to allow teachers using those devices 315 to evaluate a student's needs through a set of diagnostics, defined goals and lesson plans for the student's advancement, and monitor the student's progress. The personalized learning system 305 can support remediation and learning with personalized plans that adapt to help accelerate student success using a multi-level approach. The personalized learning system 305 can present a set of user interfaces 335, such as webpages or other graphical and/or textual presentations, to the student device 320. These user interfaces 335 can include sets of questions or problems to which the student provides answers. In this way, such as webpages or other graphical and/or textual presentations, provides an intuitive way for students to complete assignments on their tablet, personal computer, or other device. Through the student devices 320, students can receive multisensory stimulation, e.g., haptic feedback, sounds, and/or visual achievement awards, to celebrate their success and motivate them to continue learning.

More specifically, and as will be described in greater detail below, the personalized learning system 305 can maintain a set of assessments 330 used to perform diagnostics for a student through a set of questions and answers presented in a user interface 335 rendered on the student's device 320. The results of these diagnostics can be maintained, e.g., in a set of student records 340 and used by the personalized learning system 305 to generate a learning path 345 for the student. The learning path 345 can comprise a sequence of learning points for a subject to be mastered by the student. Using the learning path 345, the personalized learning system 305 can present a set of lessons 350 to the student through the user interface 335 rendered on the student's device 320 and track the student's progress against the learning path 345. As will be described in greater detail below, the learning path 345 can be generated by the personalized learning system 305 based on a set of known standards 355, e.g., state or federal learning standards, for a grade level of the student for a particular subject and a model 360 defining learning points to meet those standards 355 and connections between those points, e.g., prerequisite skills and next skills to be learned.

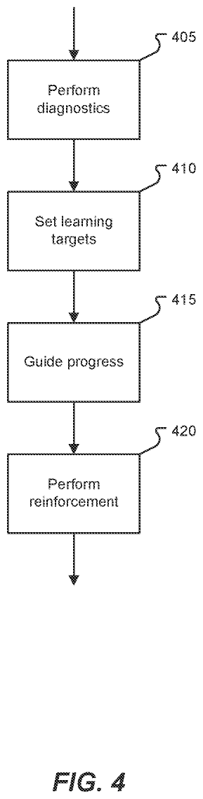

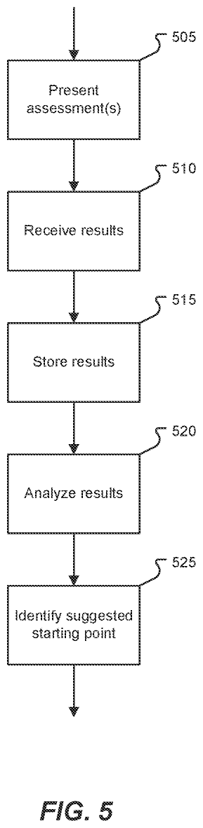

FIG. 4 is a flowchart illustrating an exemplary process for providing personalized learning intervention according to one embodiment of the present disclosure. As illustrated in this example, the process can begin with performing 405 diagnostics on the student by the personalized learning system 305. The diagnostics can be used to determine where an individual student's skills gaps exist in order to target intervention needs in a lesson or lesson plan, i.e. the student's learning path 345. The diagnostics can be based on one or more assessments 330 selected from a set of available assessments to assess the student based on a chosen skill through a series of questions. Which assessments 330 to use can be determined, for example, based on selections made by a teacher through a user interface 325 provided by the personalized learning system 305 and rendered on the teacher's device 315 or automatically based on the student's grade level and known standards for that grade level. Additional details of an exemplary process for performing 405 diagnostics will be described below with reference to FIG. 5.

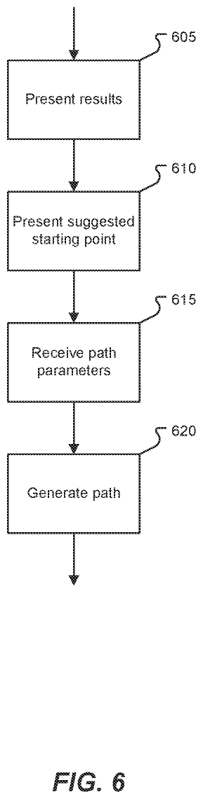

Learning targets can then be set 410 by the personalized learning system 305. Setting 410 the targets can comprise setting skill goals for individual student achievement, e.g., to support implementation of an IEP. Setting the targets can include choosing a starting point and end point with each point being a different skill. These points can be selected, for example, based on input received from a teacher through a user interface 325 provided by the personalized learning system 305 and rendered on the teacher's device 315. Additionally, or alternatively, starting points and ending points can be selected automatically by the personalized learning system 305 based on results of student diagnostics. Lessons 350 can then be presented for steps between these points, i.e., a learning path 345 for the student, and the steps can, for example, match an IEP to demonstrate performance of the plan. Additional details of an exemplary process for setting 410 learning targets will be described below with reference to FIG. 6.

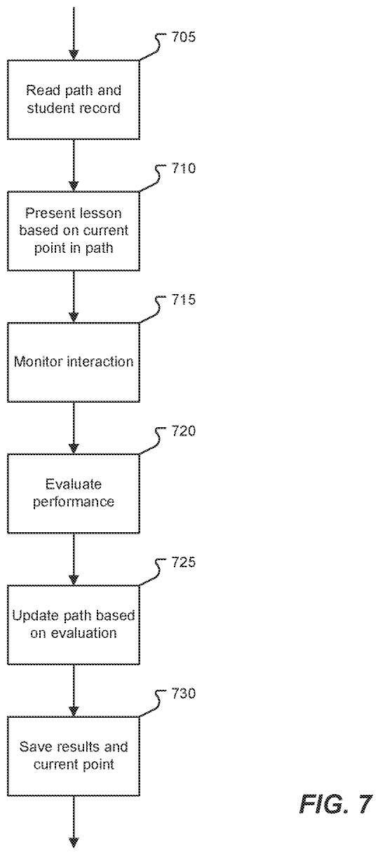

Student progress can then be guided 415 by an algorithm executed by the personalized learning system 305 and that builds from student successes and guides students forward or back along the learning path 345 based on real-time responses. In this process, the teacher can choose a starting skill and the real-time algorithm can move students forward along the learning path 345 if the skill is satisfied, i.e., enough correct answers are given to presented questions, or back along the learning path 345 to a more fundamental skill if the student is not satisfying the skill. Additional details of an exemplary process for guiding 420 student progress will be described below with reference to FIG. 7.

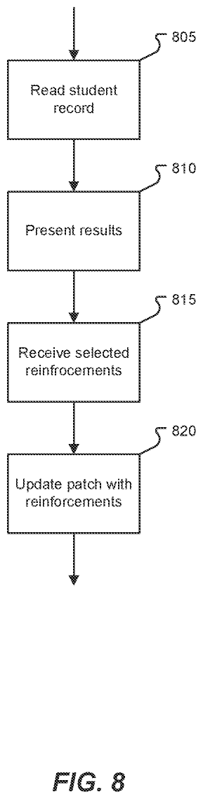

Learning reinforcement can then be performed 420 by the personalized learning system 305. This reinforcement can comprise deep practice on a particular skill without recycling the same problems or questions. This provides a way for a teacher to define a skill for the student to practice based on teacher's knowledge of the student. Additional details of an exemplary process for performing 420 learning reinforcement will be described below with reference to FIG. 8.

FIG. 5 is a flowchart illustrating additional details of an exemplary process for performing diagnostics according to one embodiment of the present disclosure. As illustrated in this example, performing the online diagnostic of the student can comprise presenting 505 one or more pre-defined assessments 330 through a user interface 335 provided by the personalized learning system and rendered on the student's device 320. As noted above, the assessments provided can be selected based on teacher input, grade level for the student and known standards 355 for that grade level, etc.

A set of results for the presented one or more assessments can be received 510, stored 515, e.g., in a student record 340, and analyzed 520 by the personalized learning system 305. Analyzing 520 or scoring the results of the assessments can be based on right and wrong answers, an amount of time to provide such answers, and/or other factors based on the student interaction with the assessment. A suggested starting point for the student's learning path can be identified 525 by the personalized learning system 305 based on results of analyzing the received set of results for the presented one or more assessments and known standards 355 for the student's grade level.

FIG. 6 is a flowchart illustrating additional details of an exemplary process for setting learning targets according to one embodiment of the present disclosure. As illustrated in this example, setting the learning targets can comprise presenting 605 by the personalized learning system 305 the set of results for the presented one or more assessments, e.g., through a user interface 325 provided by the personalized learning system 305 and rendered on the teacher's device 315. In some cases, the identified suggested starting point for the learning path 345, if any, can also be presented 610 through the user interface 325.

A set of path parameters for the learning path 345 can be received 615 by the personalized learning system 305 through the user interface 325. The set of path parameters can include, but are not limited to, one or more of a start point, e.g., an acceptance of the suggested starting point, if any, or a different starting point, an end point, and/or a time period for the learning path 345. The learning path 345 can then be generated 620 by the personalized learning system 305 based on the received 615 set of path parameters. Generating 620 the learning path 345 can be further based on a model 360 of identifying skills in a predefined set of learning standards 355 and a predefined set of connections between skills in the predefined set of learning standards 355. Such a model 360 can be based on education standards for different grade levels, e.g., known state standards, knowledge of effective teaching/learning approaches, teaching best practices, etc.

FIG. 7 is a flowchart illustrating additional details of an exemplary process for guiding progress according to one embodiment of the present disclosure. As illustrated in this example, guiding progress along the learning path 345 can comprise reading 705 by the personalized learning system 305 the learning path 345 and a current point in the learning path 345 for the student. One or more lessons 350 can be presented 710 to the student by the personalized learning system 305, e.g., through a user interface 335 provided by the personalized learning system 305 and rendered on the student's device 320, based on the current point in the learning path 345.

The personalized learning system 305 can monitor 715 student interactions with the presented 710 one or more lessons 350 and evaluate 720 performance on the presented 710 one or more lessons 350 based on monitoring 715 the student interactions with the presented one or more lessons 350. Evaluating 720 student performance can be based on right or wrong answers to questions, the amount of time spent on answers and/or the lesson 350 as a whole, and/or any of a variety of other factors. The personalized learning system 305 can then update the current point in the learning path 345, i.e., forward or backward, based on results of evaluating 720 the performance on the presented one or more lessons 350 and save 730 the results of evaluating 720 the performance on the presented one or more lessons 350 and the updated current point in the learning path 345 in the student record 340 and/or learning path 345 for that student.

FIG. 8 is a flowchart illustrating additional details of an exemplary process for performing reinforcement according to one embodiment of the present disclosure. As illustrated in this example, performing the reinforcement learning can comprise reading 805 the saved results of evaluating the performance on the presented one or more exercises and the updated current point in the learning path by the personalized learning system 305 and presenting 810, by the personalized learning system 305, the results of evaluating the performance on the presented one or more exercises and the updated current point in the learning path, e.g., through a user interface 325 rendered on the teacher's device 315. The personalized learning system 305 can then receive 815, through the user interface 325, a selection of one or more reinforcement points and update the learning path 345 for the student based on the received selection of one or more reinforcement points. In this manner, the reinforcement points can be presented in the lessons 350 provided to the student according to the learning path 345.

The present disclosure, in various aspects, embodiments, and/or configurations, includes components, methods, processes, systems, and/or apparatus substantially as depicted and described herein, including various aspects, embodiments, configurations embodiments, sub-combinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method for providing personalized learning intervention, the method comprising:
performing, by a personalized learning system, an online diagnostic of a student;
setting, by the personalized learning system, a set of learning targets for the student based on results of performing the online diagnostic;
guiding, by the personalized learning system, progress along a learning path based on the set of learning targets, wherein the learning path comprises a sequence of learning points, each learning point comprising a skill to be learned; and
performing, by the personalized learning system, reinforcement learning with the student based on results of guiding the progress along the learning path.

2. The method of claim 1, wherein performing the online diagnostic of the student comprises:
presenting one or more pre-defined assessments;
receiving a set of results for the presented one or more assessments;
storing the received set of results for the presented one or more assessments;
analyzing the received set of results for the presented one or more assessments; and
identifying a suggested starting point for the learning path based on results of analyzing the received set of results for the presented one or more assessments.

3. The method of claim 2, wherein setting the set of learning targets comprises:
presenting the set of results for the presented one or more assessments;
presenting the identified suggested starting point for the learning path;
receiving a set of path parameters for the learning path; and
generating the learning path based on the received set of path parameters.

4. The method of claim 3, wherein the set of path parameters comprises one or more of a start point, an end point, or a time period.

5. The method of claim 3, wherein generating the learning path is further based on skills in a predefined set of learning standards and a predefined set of connections between skills in the predefined set of learning standards.

6. The method of claim 3, wherein guiding progress along the learning path comprises:
reading the learning path and a current point in the learning path;
presenting one or more lessons to the student based on the current point in the learning path;
monitoring student interactions with the presented one or more lessons;
evaluating performance on the presented one or more lessons based on monitoring the student interactions with the presented one or more lessons;
updating the current point in the learning path based on results of evaluating the performance on the presented one or more lessons; and
saving the results of evaluating the performance on the presented one or more lessons and the updated current point in the learning path.

7. The method of claim 6, wherein performing the reinforcement learning comprises:
reading the saved results of evaluating the performance on the presented one or more lessons and the updated current point in the learning path;
presenting the results of evaluating the performance on the presented one or more lessons and the updated current point in the learning path;
receiving a selection of one or more reinforcement points; and
updating the learning path based on the received selection of one or more reinforcement points.

8. A system comprising:
a processor; and
a memory coupled with and readable by the processor and storing therein a set of instructions which, when executed by the processor, causes the processor to:
perform an online diagnostic of a student;
set a set of learning targets for the student based on results of performing the online diagnostic;
guide progress along a learning path based on the set of learning targets, wherein the learning path comprises a sequence of learning points, each learning point comprising a skill to be learned; and
perform reinforcement learning with the student based on results of guiding the progress along the learning path.

9. The system of claim 8, wherein performing the online diagnostic of the student comprises:
presenting one or more pre-defined assessments;
receiving a set of results for the presented one or more assessments;
storing the received set of results for the presented one or more assessments;
analyzing the received set of results for the presented one or more assessments; and
identifying a suggested starting point for the learning path based on results of analyzing the received set of results for the presented one or more assessments.

10. The system of claim 9, wherein setting the set of learning targets comprises:
presenting the set of results for the presented one or more assessments;
presenting the identified suggested starting point for the learning path;
receiving a set of path parameters for the learning path; and
generating the learning path based on the received set of path parameters.

11. The system of claim 10, wherein the set of path parameters comprises one or more of a start point, an end point, or a time period.

12. The system of claim 10, wherein generating the learning path is further based on skills in a predefined set of learning standards and a predefined set of connections between skills in the predefined set of learning standards.

13. The system of claim 10, wherein guiding progress along the learning path comprises:
reading the learning path and a current point in the learning path;
presenting one or more lessons to the student based on the current point in the learning path;
monitoring student interactions with the presented one or more lessons;
evaluating performance on the presented one or more lessons based on monitoring the student interactions with the presented one or more lessons;
updating the current point in the learning path based on results of evaluating the performance on the presented one or more lessons; and
saving the results of evaluating the performance on the presented one or more lessons and the updated current point in the learning path.

14. The system of claim 13, wherein performing the reinforcement learning comprises:
reading the saved results of evaluating the performance on the presented one or more lessons and the updated current point in the learning path;
presenting the results of evaluating the performance on the presented one or more lessons and the updated current point in the learning path;
receiving a selection of one or more reinforcement points; and
updating the learning path based on the received selection of one or more reinforcement points.

15. A non-transitory, computer-readable medium comprising a set of instruction stored therein which, when executed by a processor, causes the processor to:
perform an online diagnostic of a student;
set a set of learning targets for the student based on results of performing the online diagnostic;
guide progress along a learning path based on the set of learning targets, wherein the learning path comprises a sequence of learning points, each learning point comprising a skill to be learned; and
perform reinforcement learning with the student based on results of guiding the progress along the learning path.

16. The non-transitory, computer-readable medium of claim 15, wherein performing the online diagnostic of the student comprises:
presenting one or more pre-defined assessments;
receiving a set of results for the presented one or more assessments;
storing the received set of results for the presented one or more assessments;
analyzing the received set of results for the presented one or more assessments; and
identifying a suggested starting point for the learning path based on results of analyzing the received set of results for the presented one or more assessments.

17. The non-transitory, computer-readable medium of claim 16, wherein setting the set of learning targets comprises:
presenting the set of results for the presented one or more assessments;
presenting the identified suggested starting point for the learning path;
receiving a set of path parameters for the learning path; and
generating the learning path based on the received set of path parameters.

18. The non-transitory, computer-readable medium of claim 17, wherein generating the learning path is further based on skills in a predefined set of learning standards and a predefined set of connections between skills in the predefined set of learning standards.

19. The non-transitory, computer-readable medium of claim 17, wherein guiding progress along the learning path comprises:
reading the learning path and a current point in the learning path;
presenting one or more lessons to the student based on the current point in the learning path;
monitoring student interactions with the presented one or more lessons;
evaluating performance on the presented one or more lessons based on monitoring the student interactions with the presented one or more lessons;
updating the current point in the learning path based on results of evaluating the performance on the presented one or more lessons; and
saving the results of evaluating the performance on the presented one or more lessons and the updated current point in the learning path.

20. The non-transitory, computer-readable medium of claim 19, wherein performing the reinforcement learning comprises:
reading the saved results of evaluating the performance on the presented one or more lessons and the updated current point in the learning path;
presenting the results of evaluating the performance on the presented one or more lessons and the updated current point in the learning path;
receiving a selection of one or more reinforcement points; and
updating the learning path based on the received selection of one or more reinforcement points.
